(19) United States
(12) Patent Application Publication
(10) Pub. No.: US 2014/0253001 A1
(43) Pub. Date: Sep. 11, 2014

(54) MOTOR ROTATIONAL POSITION DETECTING DEVICE, WASHING MACHINE AND MOTOR ROTATIONAL POSITION DETECTING METHOD

(71) Applicant: KABUSHIKI KAISHA TOSHIBA, Minato-ku (JP)

(72) Inventors: Toshifumi HINATA, Tokyo (JP); Sari Maekawa, Yokohama-shi (JP)

(73) Assignee: KABUSHIKI KAISHA TOSHIBA, Minato-ku (JP)

(21) Appl. No.: 14/029,038

(22) Filed: Sep. 17, 2013

(30) Foreign Application Priority Data
Mar. 7, 2013 (JP) 2013-045298

(51) Int. Cl. H02P 21/14

(52) U.S. Cl. CPC H02P 21/146
USPC 318/400.02

(57) ABSTRACT

A motor rotational position detecting device includes a control current command output unit configured to generate and supply a torque current command and an excitation current command according to a control command for a permanent magnet motor having magnetic saliency, when receiving a control command. The control current command output unit includes a command value storage unit configured to store a value of the excitation current command supplied so that a rotational position error amount obtained by a rotational position detection unit is rendered zero when the control current command output unit supplies any torque current command value while the motor maintains any rotational position. When generating the torque current command in response to the control command, the control current command output unit is configured to read from the command value storage unit an excitation current command corresponding to the torque current command and to set the read command.

### CROSS-REFERENCE TO RELATED APPLICATIONS

This application is based upon and claims the benefit of priority from the prior Japanese Patent Application No. 2013-045298 filed on Mar. 7, 2013, the entire contents of which are incorporated herein by reference.

### FIELD

Embodiments described herein relate to a motor rotational position detecting device which detects a rotational position of a permanent magnet motor having magnetic saliency, a washing machine provided with the detecting device and a motor rotational position detecting method.

### BACKGROUND

Washing machines and the like have recently employed an arrangement of applying vector control to a permanent magnet motor thereby to improve a rotation control precision and washing machine performance with the result of reduction in electric power consumption and reduction in vibration or oscillation produced during operation. When vector control is applied to a permanent magnet motor for the purposes of high-precision and high-speed control, electrical current is controlled according to a magnetic pole control position of the motor. This control manner necessitates a position sensor. However, addition of the position sensor results in problems of ensuring a placement space of the position sensor and of an increase in wiring to connect between the position sensor and a control device as well as an increase in costs. There are further a problem of reduction in the reliability due to possible occurrence of disconnection of the wiring and a problem of maintenance of the position sensor.

In view of the foregoing problems, a sensorless control system has been provided for detecting a rotational position using saliency of permanent magnet motors or reluctance motors each having magnetic saliency. Since inductance of an electric motor changes according to a magnetic pole position, high-frequency current or high-frequency voltage is applied to the motor, and motor current and motor voltage are detected. Based on the detected current and voltage, an amount of position estimation error resulting from changes in the inductance is calculated. Proportional integral (PI) control is executed to converge the changes in the amount of position estimation error to zero with the result that a rotational position can be estimated. However, estimation precision is rendered lower as a saliency ratio (L_{q}/L_{d}) that is a ratio of d-axis inductance to q-axis inductance becomes small, whereupon the position estimation becomes difficult.

On the other hand, another system is provided in which vector control is applied to a vector axis controlling motor speed and current on the basis of a detected magnetic pole position and another vector axis observing motor position estimation value distribution, independently of each other, so that a rotational position is detected. This system is focused on a phase in which response to change occurs but not on the magnitude of the amount of position estimation error. The vector axis observing an amount of position estimation error is rotated arbitrarily so that a temporal changing state of amount of position estimation error is created. A phase component is extracted from the response to the change, and a rotational position is detected on the basis of the extracted response.

However, the saliency ratio serving as information necessary for position estimation varies by the influences of occurrence of magnetic saturation and interference between d-axis and q-axis. Since the saliency ratio becomes a minimum value in some cases, there is a possibility that a stable detection of rotational position would be difficult.

### BRIEF DESCRIPTION OF THE DRAWINGS

FIGS. 1A and 1B are functional block diagrams showing an electrical arrangement of a control device vector-controlling an electric motor in one embodiment;

FIG. 2 is a cross-sectional view of a surface permanent magnet motor;

FIG. 3 is a longitudinal side section of a drum washing-drying machine;

FIG. 4 explains changes in a motor saliency ratio on d-q axis coordinates in application of vector control;

FIG. 5 is a graph showing a condition in which a d-axis current command I_{d}_{_{—}}_{ref} is adjusted so that error of rotational position θ₂ becomes zero, in the case where the rotor is fixed and a q-axis current command I_{q}_{_{—}}_{ref} is increased from zero and further showing changes in an amount of position estimation error obtained with the adjustment;

FIG. 6B shows examples of combination of q-axis current command I_{q}_{_{—}}_{ref} and d-axis current command I_{d}_{_{—}}_{ref} both obtained by the processing as shown in FIG. 5 and FIG. 6A shows a locus of current vector on d-q coordinate axes according to the combination;

FIG. 7 is a flowchart showing operation of a rotational position detecting section, a position estimation error amount calculating section and an angle compensation value calculating section;

FIGS. 8A to 8D are views similar to FIGS. 5A to 5D respectively, showing the case where the motor is actually controlled; and

FIG. 9A shows changes in the position estimation error amount in a related art and FIG. 9B shows changes in the estimation error amount in the embodiment.

### DETAILED DESCRIPTION

In general, according to one embodiment, a motor rotational position detecting device comprises a control current command output unit which is configured to generate and supply a torque current command and an excitation current command according to a control command for a permanent magnet motor having magnetic saliency, when receiving the control command. A control voltage command output unit is configured to generate a voltage command according to the torque current command and the excitation current command. The voltage command is supplied to a drive unit of the motor. A detection voltage command generation unit is configured to generate an AC detection voltage command to detect a rotational position of the motor. A current detection unit is configured to detect current flowing into the motor. A coordinate conversion unit is configured to vector-convert the current detected by the current detection unit into an excitation component and a torque component both represented by a d-q orthogonal coordinate system, based on a phase angle obtained at any rotational frequency. A position estimation error amount calculation unit is configured to calculate an amount of position estimation error based on characteristics of the motor, from the detection voltage command and the current converted by the coordinate conversion unit. A rotational position detection unit is configured to calculate a frequency and a phase of the position estimation error amount obtained by the position estimation error amount calculation unit, thereby converting the phase of the position estimation error amount to a rotational position of the motor. In the motor rotational position detecting device, the control current command output unit includes a command value storage unit which is configured to store a value of the excitation current command supplied so that the rotational position error amount obtained by the rotational position detection unit is rendered zero when the control current command output unit supplies any value of the torque current command while the motor maintains any rotational position. When generating the torque current command in response to the control command for the motor, the control current command output unit is configured to read from the command value storage unit an excitation current command corresponding to the torque current command and to set the read excitation current command.

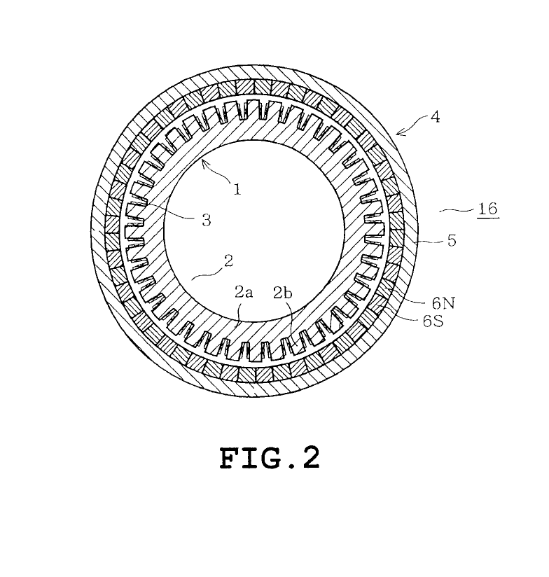

One embodiment will be described with reference to the drawings. Referring first to FIG. 2, the construction of a surface permanent magnet motor (SPM motor) is shown in the form of a cross section. The permanent magnet motor includes a stator 1 and a rotor 4. The stator 1 includes a stator core 2 and stator windings 3. The stator core 2 has, for example, 36 teeth 2b which are formed so as to protrude to an outer circumferential side of an annular body 2a thereof. Three-phase stator windings 3 are wound on the teeth 2b, for example. The rotor 4 includes an annular rotor core 5 disposed around the outer circumference of the stator 1 and a plurality of, for example, 26 permanent magnets 6. The permanent magnets 6 are disposed in a recess formed in an inner circumferential side of the rotor core 5 so that a north pole and a south pole are alternately arranged (N, S, N, S . . . ). As a result, the permanent magnet motor is configured into an outer rotor type 52-pole 36-slot motor 16.

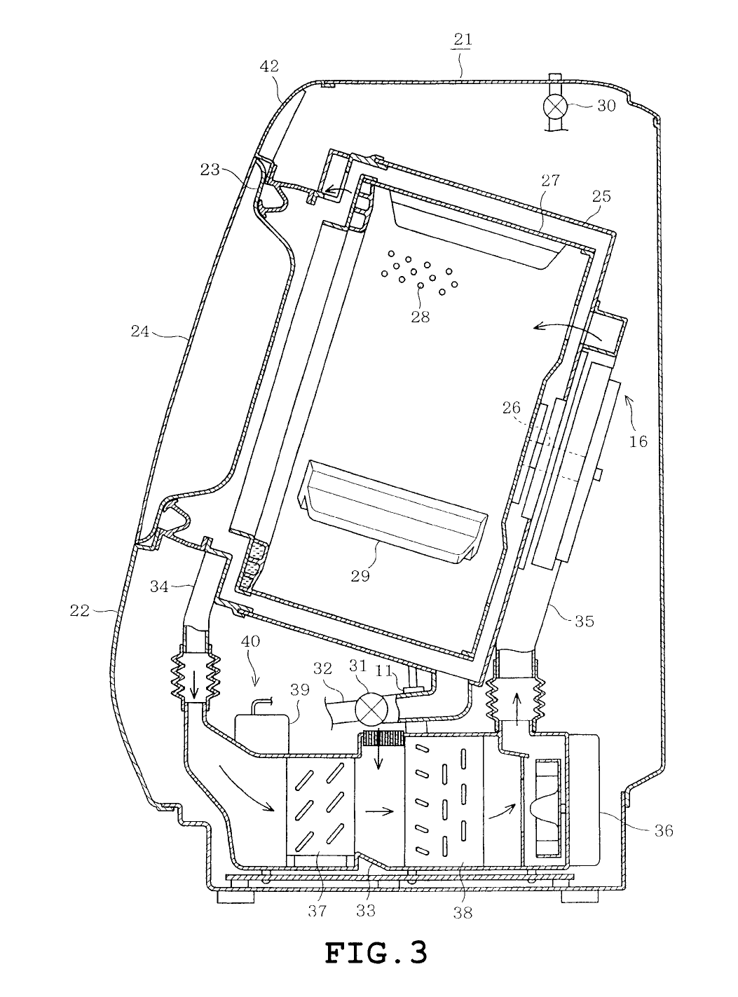

Referring now to FIG. 3, a drum washing-drying machine 21 is shown in the form of a longitudinal side section. The washing-drying machine 21 includes an outer casing 22 constituting an outer shell of the drum washing-drying machine 21. The outer casing 22 has a front having a circularly open laundry access hole 23. A door 24 is mounted to the front of the outer casing 22 so as to close and open the access hole 23. A bottomed cylindrical water tub 25 having a closed rear is disposed in the outer casing 22. The stator 1 of the permanent magnet motor 16 serving as a washing motor is secured to the central rear of the water tub 25 by screws. The water tub 25 is supported by suspension 11.

The motor 16 includes a rotating shaft 26 having a rear end (a right end in FIG. 3) fixed to the rotor thereof and a front end (a left end in FIG. 3) protruding into the interior of the water tub 25. A bottomed cylindrical drum 27 having a closed rear is fixed to the front end of the rotating shaft 26 so as to be coaxial with the water tub 25. The drum 27 is rotated together with the rotating shaft 26 by the driving of the motor 16. The drum 27 is formed with a number of circulation holes 28 through which air and water are passable and a plurality of baffles 29 for scooping up and detangling laundry in the drum 27.

A water-supply valve 30 is connected to the water tub 25 to supply water into the water tub 25 when opened. A drain hose 30 provided with a drain valve 31 is also connected to the water tub 25. When the drain valve 31 is opened, water in the water tub 25 is discharged through the drain valve 31 and the drain hose 30. An air duct 33 extending in the front-back direction is mounted below the water tub 25. The air duct 33 has a front end communicating via a front duct 34 with the interior of the water tub 25 and a rear end communicating via a rear duct 35 with the interior of the water tub 25. A blowing fan 36 is provided on the rear end of the air duct 35. Air in the water tub 25 is caused to flow from the front duct 34 into the air duct 33 by a blowing action of the blowing fan 36 as shown in arrows in FIG. 3, being returned through the rear duct 35 into the water tub 25.

An evaporator 37 is disposed at the front end side in the interior of the air duct 33 and a condenser 38 is disposed at the rear end side in the interior of the air duct 33. A heat pump 40 includes the evaporator 37, the condenser 38, a compressor 39 and a throttle valve (not shown). Air flowing through the air duct 33 is dehumidified by the evaporator 37 and heated by the condenser 38 to be circulated into the water tub 25.

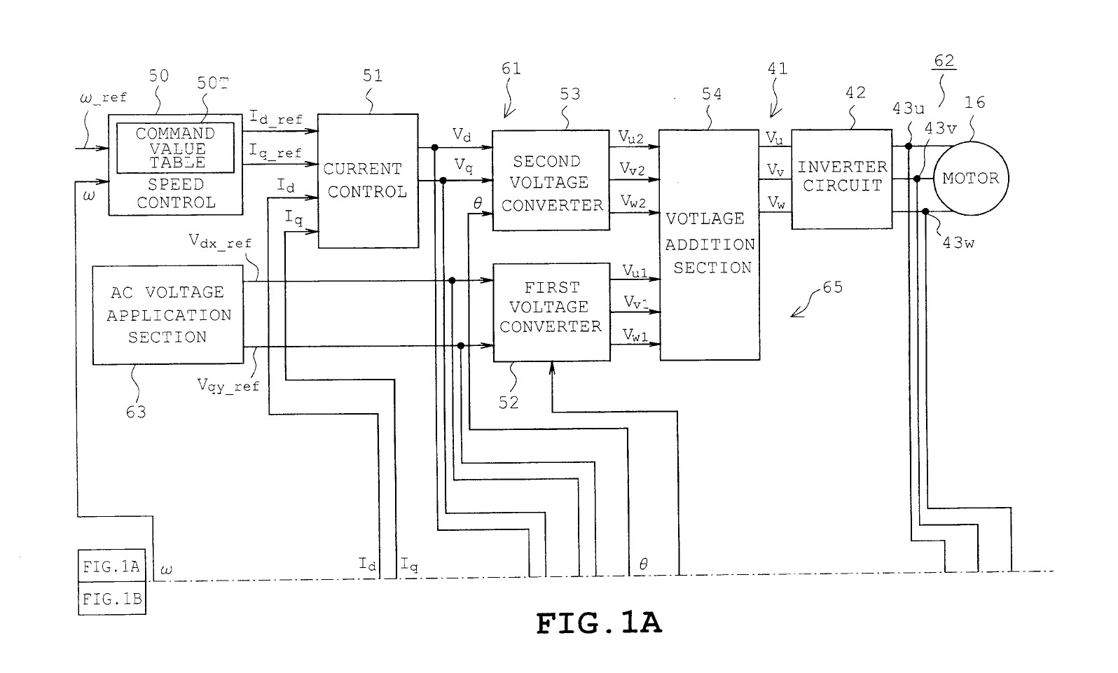

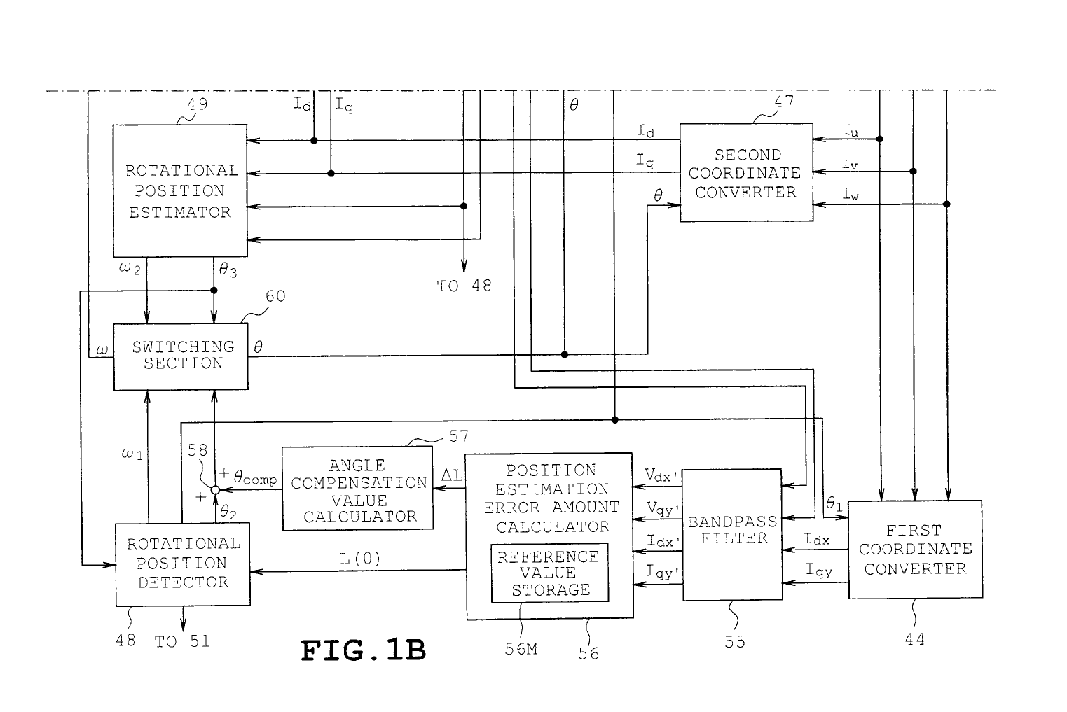

Referring to FIGS. 1A and 1B, an electrical arrangement of a motor control device 41 applying vector control to the motor 16 is shown in the form of a functional block diagram. The configuration except for an inverter circuit (drive unit) 42 is realized by a software process executed by a microcomputer. The microcomputer is provided with an input/output port, a serial communication circuit, an A/D converter for entering analog signals such as a current detection signal, a timer provided for carrying out PWM process, and the like.

Motor current detecting sections (current detection units) 43u, 43v and 43w serve as current detectors provided on output lines of the inverter circuit 42 for detecting U-phase, V-phase and W-phase currents Iᵤ, Iᵥ and I_{w} respectively. Current detection signals generated by the motor current detecting sections 43u, 43v and 43w are supplied to an A/D converter (not shown) in the motor control device 41 to be converted to digital data. A first coordinate converter (a first coordinate conversion unit) 44 converts three-phase currents Iᵤ, Iᵥ and I_{w} to two-phase currents I_{α} and I_{β}. The first coordinate converter 44 further converts currents I_{α} and I_{β} of coordinate system at rest to currents I_{dx} and I_{qy} of rotating coordinate system (x-y coordinate system), based on a rotation phase angle θ₁ supplied from a rotational position detector 48 as will be described later.

An AC voltage application section (a detection voltage command generation unit) 63 supplies, as rotational position detection voltage commands V_{dx}_{_{—}}_{ref} and V_{qy}_{_{—}}_{ref}, AC voltages having sufficiently higher frequencies (about several hundreds Hz, for example) than an operating frequency of the motor 16. These voltage commands V_{dx}_{_{—}}_{ref} and V_{qy}_{_{—}}_{ref} are sinusoidal voltages having respective phases shifted from each other by 90 degrees along x-axis and y-axis and the same amplitude (about one tenths of the motor rated current, for example). The V_{dx}_{_{—}}_{ref} and V_{qy}_{_{—}}_{ref} are supplied to a first voltage converter 52.

A second coordinate converter (a second coordinate conversion unit) 47 converts three-phase currents Iᵤ, Iᵥ and I_{w} to two-phase currents I_{α} and I_{β}. The second coordinate converter 47 further converts currents I_{α} and I_{β} of coordinate system at rest to currents I_{d} and I_{q} of rotating coordinate system (d-q coordinate system), based on a rotational position θ₂ calculated by the rotational position detector 48 (a rotational position detection unit, a frequency detection unit) or a rotational position θ₃ calculated by a rotational position estimator (a rotational position estimation unit) 49.

Based on a speed control command ω_{_{—}}_{ref} supplied from a high-order system, a speed control (a control current command output unit) 50 calculates a q-axis current command I_{q}_{_{—}}_{ref} so that a motor speed ω supplied via a switching section 60 which will be described later follows the speed control command ω_{_{—}}_{ref}. The speed control 50 is provided with a command value table 50T (a command value storage unit) which is set with values of d-axis current command I_{d}_{_{—}}_{ref} to be supplied according to the value of q-axis current command I_{q}_{_{—}}_{ref}. The speed control 50 sets the d-axis current command I_{d}_{_{—}}_{ref} based on the command value table 50T. The command value table 50T will be described later.

A current control (a control voltage command output unit) 51 controls the currents I_{d} and I_{q} converted by the second coordinate converter 47 based on the d-axis and q-axis current commands I_{d}_{_{—}}_{ref} and I_{q}_{_{—}}_{ref} supplied from the speed control 50, thereby supplying voltage commands V_{d} and V_{q}. A first voltage converter (a first voltage conversion unit) 52 converts voltage commands V_{dx}, and V_{qy} of x-y conversion system to voltage commands Vᵤ₁, Vᵥ₁ and V_{w1}, based on the phase angle θ₁. A second voltage converter (a second voltage conversion unit) 53 converts the voltage commands V_{d} and V_{q} of d-q conversion system to voltage commands Vᵤ₂, Vᵥ₂ and V_{w2}, based on the rotational position θ supplied via the switching section 60.

A voltage addition section (a voltage command addition unit) 54 adds voltage commands Vᵤ₁, Vᵥ₁ and V_{w1} supplied from the first voltage converter 52 and voltage commands Vᵤ₂, Vᵥ₂ and V_{w2} supplied from the second voltage converter 53 thereby to obtain voltage commands Vᵤ, Vᵥ and V_{w}. The voltage addition section 54 further supplies to the inverter circuit 42 PWM signals Vᵤₚ, Vᵤₙ, Vᵥₚ, Vᵥₙ, V_{wp} and V_{wn} generated on the basis of the voltage commands Vᵤ, Vᵥ and V_{w}. The inverter circuit 43 is composed of six IGBTs (semiconductor switching elements) connected into a three-phase full bridge configuration although not shown.

A bandpass filter 55 has a passband that is set so as to extract frequency components of the x-y coordinate system currents I_{dx} and I_{qy} converted by the first coordinate converter 44 and the AC voltages V_{dx}_{_{—}}_{ref} and V_{qy}_{_{—}}_{ref}. A position estimation error amount calculator (a position estimation error amount calculation unit) 56 calculates an amount of position estimation error from frequency components of AC currents I_{dx}′, I_{qy}′, V_{dx}′ and V_{qy}′ that are outputs of the bandpass filter 55. The calculated amount of position estimation error has the same tendency as an angular distribution of inductance based on the magnetic saliency of the motor 16.

For example, the symbol H is calculated from the foregoing outputs I_{dx}′, I_{qy}′, V_{dx}′ and V_{qy}′ of the bandpass filter 55, using the following equation (00):

H=V_{qy}′×I_{qy}′−V_{dx}′×I_{dx}′ (00)

The position estimation error amount L is obtained by extracting only DC components after H is further supplied to the bandpass filter in order that frequency component twice as high as the current command frequency may be eliminated.

Furthermore, the position estimation error amount calculator 56 includes a reference value storage 56M (a reference value storage unit). The reference value storage 56M stores, as a reference value, the value of position estimation error amount calculated when error of an estimated rotational position becomes zero in the case where a pair of q-axis current command I_{q}_{_{—}}_{ref} and d-axis current command I_{d}_{_{—}}_{ref} to be stored in the command value table 50T is obtained. When calculating the position estimation error amount L in an actual control of the motor 16, the position estimation error amount calculator 56 obtains the deviation ΔL between the position estimation error amount L and the aforementioned reference value to supply the obtained deviation ΔL to an angle compensation value calculator 57.

The rotational position detector 48 extracts frequency and phase components of the position estimation error amount calculated by the position estimation error amount calculator 56. Since the extracted phase component θL₁ is the phase corresponding to the frequency twice as high as the rotational position of the motor 16, the extracted phase component θL₁ is converted to a phase component ΔL₂ having a one-half frequency. When rotational angle θ₁ is added to phase component θL₂ and the rotational position θ₂ is calculated, a rotational frequency ω₁ is calculated from a differential value of rotational position θ₂. Furthermore, the rotational frequency θ₁ is delayed by a delay device into frequency ƒ₁(1) obtained one control period before. A predetermined frequency ω₀ is added to the frequency ω₁(1), and a resultant frequency [ω₁(1)+ω₀] is integrated. A phase angle θ₁ obtained by the integration is supplied to the first coordinate converter 44 and the first voltage converter 52.

An angle compensation value calculator 57 (a position compensation unit) supplies to an adder 58 an angle compensation value θ_{comp} according to the supplied deviation ΔL. The adder 58 adds the angle compensation value θ_{comp} to the rotational position θ₂ supplied from the rotational position detector 48, supplying the addition as a rotational position θ₃ to the switching section 60.

A rotational position estimator 49 estimates a motor speed ω₂ using a d-axis motor voltage equation (1). The rotational position estimator 49 also integrates the motor speed ω₂ to calculate a rotational position θ₃.

V_{d}=R·I_{d}−ω·L_{q}·I_{q} (1)

where L_{q} is a q-axis component of inductance of the motor 16. The switching section 60 selects and supplies the detection value θ₂ of the rotational position detector 48 or the estimation value θ₃ of the rotational position estimator 49 as the motor frequency ω and the rotational position θ used by the second coordinate converter 47, the speed control 50 and the second voltage converter 53.

The above-described configuration except for the motor 16 constitutes the motor control device 41. The configuration of the motor control device 41 except for the inverter circuit 42 constitutes a motor rotational position detecting device. Furthermore, the motor control device 41 and the motor 16 constitute a motor drive system 62.

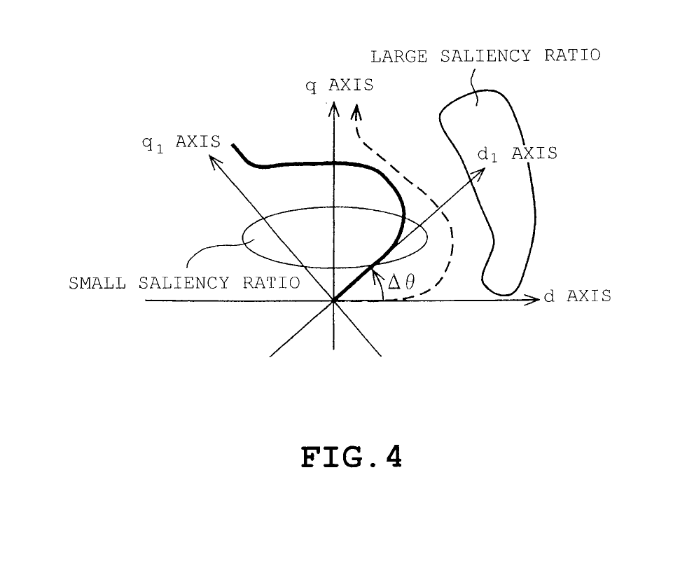

The operation of the embodiment will now be described with reference to FIGS. 4 to 8 as well as FIGS. 1 to 3. The description of a basic operation to calculate the position estimation error amount L to detect a rotational position is eliminated. FIG. 4 shows that when vector control is applied to the motor using d-axis and q-axis currents, there exist a range in which a saliency ratio of the motor becomes extremely small on the d-q axis coordinate (a gaping range including an extremely small value, an extremely small value range) and a range in which a saliency ratio of the motor becomes extremely large on the d-q axis coordinate (a gaping range including an extremely large value, an extremely large value range).

In FIG. 4, the d-axis and q-axis are coordinate axes based on an actual rotation angle, whereas d₁-axis and q₁-axis are coordinate axes based on an estimated rotation angle. When a locus of current vector depending upon d-axis and q-axis current values as shown by solid line in FIG. 4 enters the extremely small value range, there is a case where position estimation is difficult. Furthermore, when the locus of current vector enters the extremely large value range, there is a possibility that overflow may occur in operational processing in a microcomputer composing the motor control device 41. Accordingly, it is desirable that the current vector locus should be avoided from entering the extremely large value range.

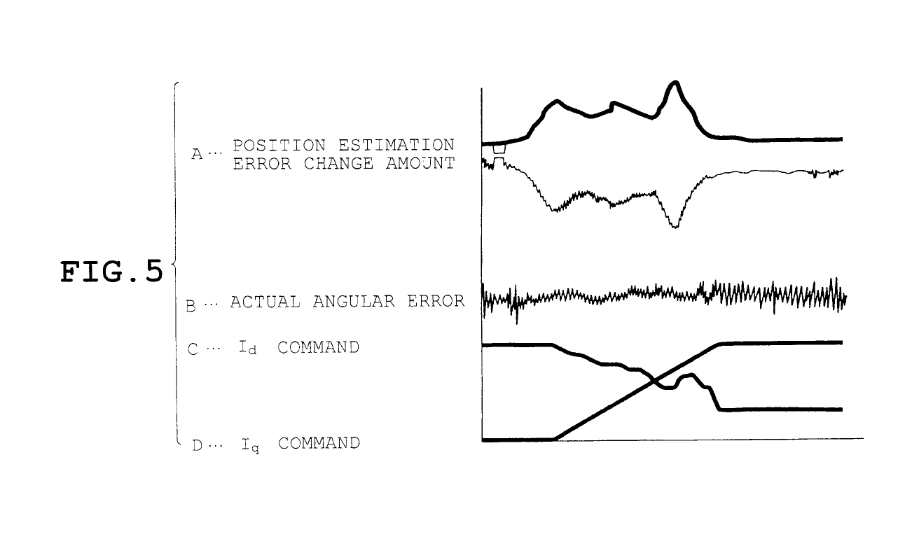

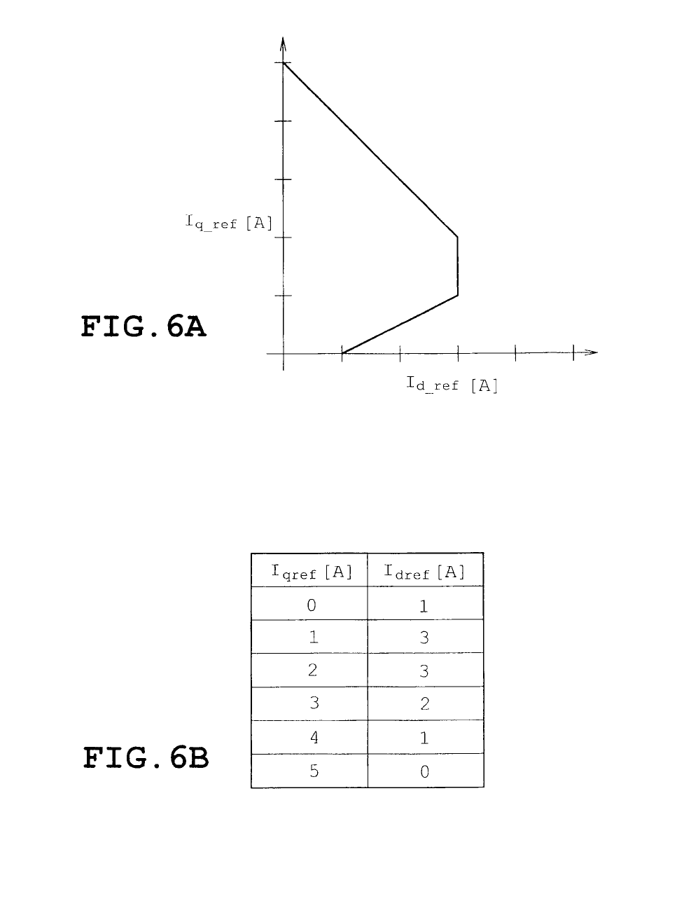

Regarding the current vector during the control, the locus can be changed when a d-axis current command I_{d}_{_{—}}_{ref} is also imparted in output of a q-axis current command I_{g}_{_{—}}_{ref} that is a subject of control. In the embodiment, the value of d-axis current command I_{d}_{_{—}}_{ref} corresponding to the q-axis current command I_{q}_{_{—}}_{ref} is previously obtained so that the current vector locus can avoid the extremely small and large value ranges in execution of vector control. A combination of d-axis and q-axis current commands is used in actual control of the motor 16. A control manner using the combination will be described with reference to FIGS. 5 and 6 as follows.

FIG. 5 shows signal waveforms showing the condition where the value of d-axis current command is adjusted (c) so that error of rotational position θ₂ obtained from the rotational position detector 48 is eliminated with respect to each value (b) when the q-axis current command I_{q}_{_{—}}_{ref} is increased from 0 with the rotor 4 of the motor 16 being fixed, that is, with the rotational position being constant (d). An encoder or the like is used for the position detection so that an accurate angle is obtained. Furthermore, the value of position estimation error amount L (a) calculated by the position estimation error calculator 56 is also previously obtained as a reference amplitude value according to each combination of q-axis current command I_{q}_{_{—}}_{ref} and d-axis current command I_{d}_{_{—}}_{ref}.

FIG. 6B shows examples of combination of q-axis current command I_{g}_{_{—}}_{ref} and d-axis current command I_{d}_{_{—}}_{ref}. FIG. 6A shows a locus of current vector on the d-q coordinate according to the combination. The combination of command values is stored in the speed control 50 as the command value table 50T. Furthermore, the reference amplitude value of the position estimation error amount L is stored in the reference value storage 56M of the position estimation error amount calculator 56.

The current vector locus shown in FIG. 6A indicates that the rotational position θ₂ is reliably obtained without error based on the position estimation error amount L as described above. As a result, the locus avoids the extremely small value range of salient ratio shown in FIG. 4. Furthermore, the locus can avoid the extremely small value range of saliency ratio shown in FIG. 4. In this case, furthermore, since the d-axis current command I_{d}_{_{—}}_{ref} is of course provided with an upper limit, the locus can also avoid the extremely large value range of saliency ratio.

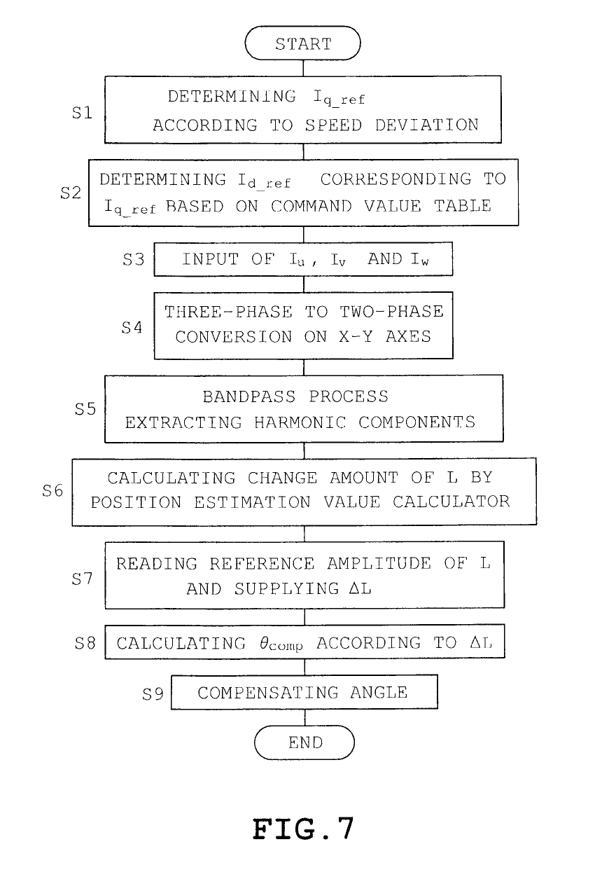

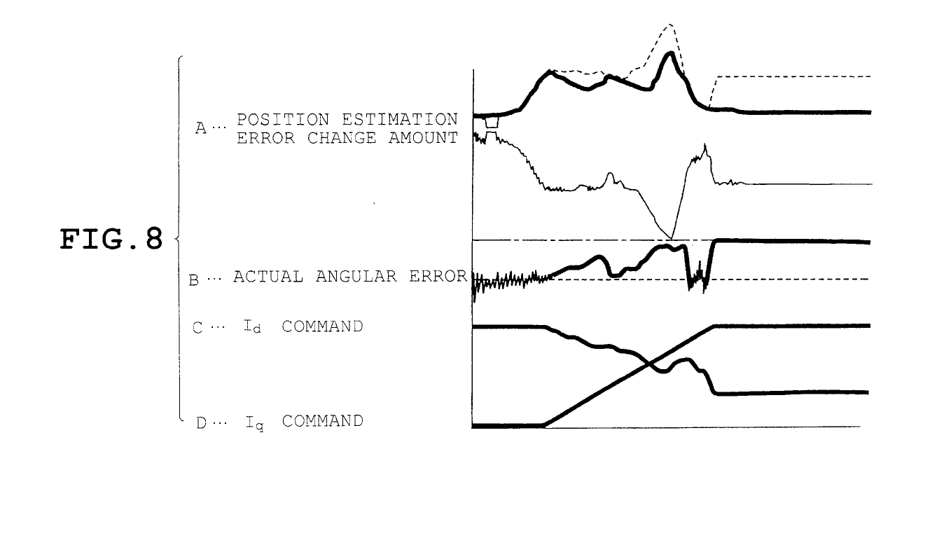

The control contents in the case of actual vector control of the motor 16 will be described with reference to FIGS. 7 and 8. FIG. 7 mainly shows operations of the rotational position detector 48, the position estimation error amount calculator 56 and the angle compensation value calculator 57. The speed control 50 carries out, for example, a PI control operation based on a deviation between the speed control command ω_{_{—}}_{ref} and motor speed w supplied via the switching section 60 thereto, thereby calculating a q-axis current command I_{q-ref} (S1). The speed control 50 then sets a d-axis current command I_{d}_{_{—}}_{ref} to be supplied according to the value of q-axis current command I_{q-ref} (S2).

When supplied with three-phase currents Iᵤ, Iᵥ and I_{w} (S3), the first coordinate converter 44 carries out a three-phase to two-phase conversion on the X-Y axes thereby to supply two-phase current signals I_{dx} and I_{qy}(S4). When supplied with the two-phase current signals I_{dx} and I_{qy} and two-phase voltage signals V_{dx}_{_{—}}_{ref} and V_{qy}_{_{—}}_{ref} supplied from an AC voltage application section 63, the bandpass filter 55 filters the supplied signals to extract harmonic components. The bandpass filter 55 then supplies current signals I_{dx}′ and I_{qy}′ and voltage signals V_{dx}′ and V_{qy}′ to the position estimation error amount calculator 56 (S5). The position estimation error amount calculator 56 calculates a change amount of position estimation error amount L based on the input signals (S6).

Reference is now made to FIG. 8-A. When the motor 16 is actually driven in a sensorless drive manner and the vector control is executed, there occurs a slight error between an actual rotational position and an estimated rotational position. The saliency ratio is then changed by angular deviation associated with the error, and amplitude of the position estimation error amount L is changed as shown by broken line in FIG. 8-A. Accordingly, the value of position estimation error amount L deviates from the reference amplitude value stored in the reference value storage 56M. Since the deviation has a correlation with error of the rotational position obtained by the rotational position detector 48 on the basis of the above-described causal connection (see FIG. 8-B), angular compensation is executed using this relationship.

Reference is now made to FIG. 7 again. When reading the reference amplitude value stored in the reference value storage 56M, the position estimation error amount calculator 56 obtains the deviation ΔL between the calculated position estimation error amount L and the reference amplitude value, thereby supplying the deviation ΔL to the angle compensation value calculator 57 (S7). The angle compensation value calculator 57 then determines an angle compensation value θ_{comp} according to the deviation ΔL and supplies the angle compensation value θ_{comp} to the adder 58 (S8), so that angular compensation is carried out and the rotational position θ₃ is supplied to the switching section 60 (S9). That is, since the angular error as shown in FIG. 8-B can be reduced when the rotational position θ₂ is compensated for, the precision of the rotational position θ₃ can be improved.

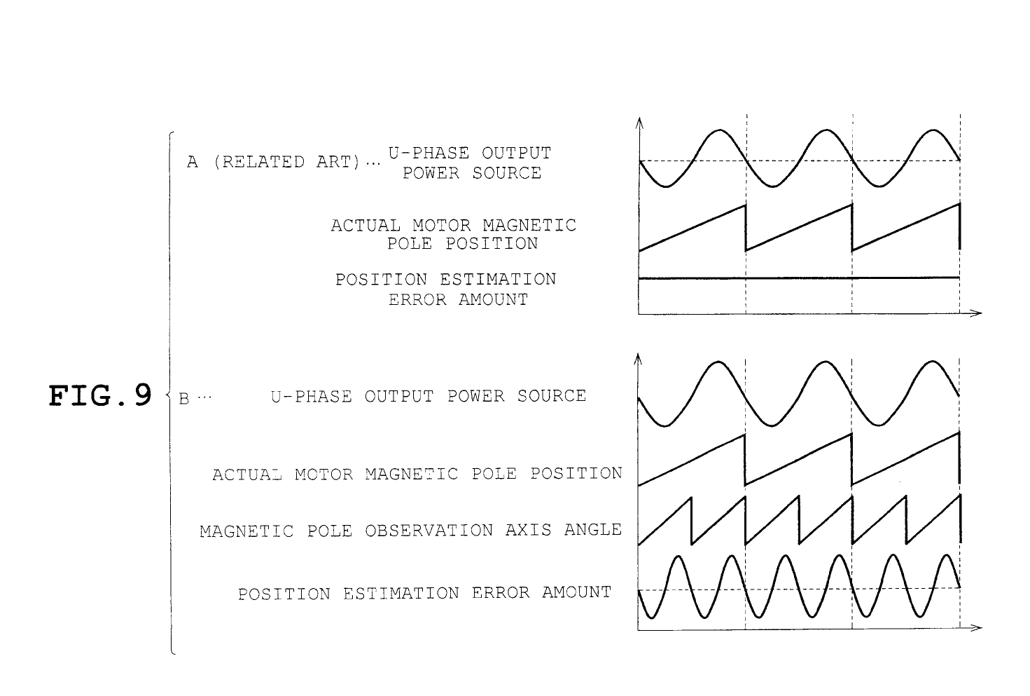

The amplitude of position estimation error amount component cannot be used for the above-described angular compensation in the control manner that a change amount of the position estimation error amount is zeroed by the PI control as in the related art shown in FIG. 9-A. On the other hand, the position estimation error amount normally changes in the control manner that the coordinate axes are separately provided to observe the position estimation error amount and a predetermined rotational speed difference is imparted as in the embodiment (see FIG. 9-B), with the result that amplitude information is usable for angular compensation. The changing frequency of the position estimation error amount appears as twofold of the difference between an actual rotational speed of the motor 16 and a rotational speed T of observational coordinates.

In the above-described embodiment, the position estimation error amount calculator 56 calculates the position estimation error amount L on the basis of the saliency of the motor 16, based on the voltage commands V_{dx}_{_{—}}_{ref} and V_{qy}_{_{—}}_{ref} and the currents I_{dx} and I_{qy} converted by the first coordinate converter 44. The rotational position detector 48 then calculates the frequency and phase of the obtained position estimation error amount L, thereby converting the phase of the position estimation error amount L to the rotational position θ₂.

The command value table 50T of the speed control 50 stores the value of excitation current command I_{d}_{_{—}}_{ref} supplied so that an error of rotational position θ₂ obtained by the rotational position detector 48 is zeroed when any value of the torque current command I_{q}_{_{—}}_{ref} is supplied while the motor 16 maintains any rotational position. When generating the torque current command I_{q}_{_{—}}_{ref} according to the control command ω_{ref} of the motor 16, the speed control 50 reads and sets the excitation current command I_{d}_{_{—}}_{ref} corresponding to the torque current command I_{q}_{_{—}}_{ref}. Accordingly, since the motor 16 is vector-controlled while the extremely small value range and the extremely large value range of the saliency ratio are avoided, the rotational position θ₂ of normally high detection precision can be obtained by the rotational position detector 48.

Furthermore, the position estimation error amount calculator 56 is provided with the reference value storage 56M storing the reference value of the position estimation error amount L calculated when any torque current command and the excitation current command I_{d}_{_{—}}_{ref} stored in the command value table 50T are supplied in the case where the motor 16 maintains any rotational position. The position estimation error amount calculator 56 then generates and supplies the difference ΔL between the reference value and the position estimation error amount L calculated during drive control of the motor 16. The angle compensation value calculator 57 calculates the compensation value θ_{comp} of the rotational position according to the difference ΔL, compensating the rotational position θ₂ converted by the rotational position detector 48 using the compensation value θ_{comp}. Accordingly, even when an error occurs between the actual rotational position and the estimated rotational position in the case where the motor 16 is actually driven in the sensorless drive manner and controlled by the vector control, the error is compensated and the detection precision of the rotational position can further be improved.

Furthermore, the drum washing-drying machine 21 includes the permanent magnet motor 16, the motor rotational position detecting device 61 which detects the rotational position of the motor 16, and the inverter circuit 42. The motor 16 is vector-controlled in the sensorless control manner so that a washing operation is executed by a rotational driving force generated by the motor 16. Consequently, the magnetic pole position θ of the motor 16 is detected and the vector control can be executed without provision of a position sensor such as Hall IC with the result that a low cost and high performance washing-drying machine can be constructed.

In a modified form, all the three-phase motor currents need not be detected. Only two phase currents may be detected and the other phase current may be obtained by calculation.

The phase angle θ₁ supplied to the first coordinate converter 44 need not be set based on the motor frequency (θ₁. The phase angle θ₁ may be any phase angle based on any frequency differing from the rotational frequency of the motor 16. Furthermore, rotation of the observed coordinate system may be stopped without supply of the phase angle θ₁ while the motor 16 is being rotated.

A configuration only to estimate a rotational position of the motor does not necessitate the second coordinate converter 47, the rotational position estimator 49, the speed control 50, the current control 51, the second voltage converter 53 and the voltage control section 59.

Permanent magnet motors of the inner rotor type may be used instead of the above-described motor 16 of the outer rotor type. Furthermore, an interior permanent magnet motor (IPM motor) may be used.

The angle compensation value calculator 57 may be eliminated, for example, when the motor has a relatively larger saliency ratio and an estimated error of the rotation position becomes extremely small in the actual control.

The foregoing embodiment may be applied to a washing machine without a drying function.

The motor rotational position detecting device should not be limited to the washing-drying machine and the washing machine but may be applied to a compressor motor composing a heat pump system of an air conditioner, for example. Thus, the motor rotational position detecting device may be applied to any electrical equipment using a permanent magnet motor having magnetic saliency.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. A motor rotational position detecting device comprising:
a control current command output unit which is configured to generate and supply a torque current command and an excitation current command according to a control command for a permanent magnet motor having magnetic saliency, when receiving the control command;
a control voltage command output unit which is configured to generate a voltage command according to the torque current command and the excitation current command, the voltage command being supplied to a drive unit of the motor;
a detection voltage command generation unit which is configured to generate an AC detection voltage command to detect a rotational position of the motor;
a current detection unit which is configured to detect current flowing into the motor;
a coordinate conversion unit which is configured to vector-convert the current detected by the current detection unit into an excitation component and a torque component both represented by a d-q orthogonal coordinate system, based on a phase angle obtained at any rotational frequency;
a position estimation error amount calculation unit which is configured to calculate an amount of position estimation error based on characteristics of the motor, from the detection voltage command and the current converted by the coordinate conversion unit; and
a rotational position detection unit which is configured to calculate a frequency and a phase of the position estimation error amount obtained by the position estimation error amount calculation unit, thereby converting the phase of the position estimation error amount to a rotational position of the motor, wherein the control current command output unit includes a command value storage unit which is configured to store a value of the excitation current command supplied so that the rotational position error amount obtained by the rotational position detection unit is rendered zero when the control current command output unit supplies any value of the torque current command while the motor maintains any rotational position; and
when generating the torque current command in response to the control command for the motor, the control current command output unit is configured to read from the command value storage unit an excitation current command corresponding to the torque current command and to set the read excitation current command.

2. The device according to claim 1, wherein the position estimation error amount calculation unit includes a reference value storage unit which is configured to store a reference value of the position estimation error amount calculated when supplied with any torque current command and the excitation current command to be stored in the storage unit while the motor maintains any rotational position; and
the position estimation error amount calculation unit is configured to supply a difference between the position estimation error amount calculated during drive control of the motor and the reference value; and
the position estimation error amount calculation unit includes a position compensation unit which is configured to calculate a compensation value of the rotational position according to the difference and to compensate for the rotational position converted by the rotational position detection unit using the compensation value.

3. A washing machine comprising:
a permanent magnet motor having magnetic saliency and generating a rotational drive force;
a motor rotational position detecting device configured as specified in claim 1 and detecting a rotational position of the motor;
a voltage conversion unit which is configured to convert the voltage command to a multiphase drive voltage signal based on a rotational position of the motor; and
a drive unit which is configured to drive the motor based on the multiphase drive voltage signal.

4. A washing machine comprising:
a permanent magnet motor having magnetic saliency and generating a rotational drive force;
a motor rotational position detecting device configured as specified in claim 1 and detecting a rotational position of the motor;
a voltage conversion unit which is configured to convert the voltage command to a multiphase drive voltage signal based on a rotational position of the motor; and
a drive unit which is configured to drive the motor based on the multiphase drive voltage signal.

5. A method of detecting a motor rotational position, comprising:
receiving a control command for a permanent magnet motor having magnetic saliency and generating and supplying a torque current command and an excitation current command according to the control command;
generating a voltage command according to the torque current command and the excitation current command, the voltage command being supplied to a drive unit of the motor;
generating an AC detection voltage command to detect a rotational position of the motor;
vector-converting electrical current flowing into the motor to an excitation component and a torque component both represented by a d-q orthogonal coordinate system, based on a phase angle obtained at any rotational frequency;
calculating an amount of position estimation error based on characteristics of the motor, from the detection voltage command and the vector-converted current; and
in calculating a frequency and a phase of the obtained position estimation error amount, thereby converting the phase of the position estimation error amount to a rotational position of the motor, storing a value of the excitation current command supplied so that the rotational position error amount is rendered zero when any value of the torque current command is supplied while the motor maintains any rotational position; and
when the torque current command has been generated in response to the control command for the motor, reading an excitation current command corresponding to the torque current command and to set the read excitation current command.

6. The method according to claim 5, further comprising:
storing a reference value of the position estimation error amount calculated when supplied with any torque current command and the excitation current command to be stored while the motor maintains any rotational position;
supplying a difference between the position estimation error amount calculated during drive control of the motor and the reference value; and
calculating a compensation value of the rotational position according to the difference and compensating for the converted rotational position using the compensation value.
